(19) United States
(12) Patent Application Publication
(10) Pub. No.: US 2021/0039953 A1
(43) Pub. Date: Feb. 11, 2021

(54) METHOD OF ASSEMBLING NANOMATERIALS MADE FROM GRAPHENE

(71) Applicant: Tatyana Sergeevna Zhebeleva, Moscow (RU)

(72) Inventor: Sergej Ivanovich ZHEBELEV, KALININGRAD (RU)

(73) Assignee: Tatyana Sergeevna ZHEBELEVA, Moscow (RU)

(21) Appl. No.: 16/468,272

(22) PCT Filed: Jan. 9, 2018
(86) PCT No.: PCT/RU2018/000002

§ 371 Date: Jun. 10, 2019

(30) Foreign Application Priority Data
Dec. 13, 2016 (RU) 2016149001

(51) Int. Cl. C01B 32/194; H01G 11/36; H01G 11/86; H01G 11/34

(52) U.S. Cl. CPC C01B 32/194; H01G 11/36; B82Y 30/00; H01G 11/34; H01G 11/86

(57) ABSTRACT

The invention relates to the field of producing carbon nanomaterials, and can be used in the manufacture of electrodes in supercapacitors. The nanomaterials are produced from graphene by means of graphene sheet assembly using a method characterised in that, for said assembly, the graphene sheets undergo an electrodynamic fluidisation in which the chemically active edges of the graphene sheets connect during counter-collisions between oppositely charged sheets, resulting in the formation of covalent bonds and in the subsequent formation of aggregates and macrostructures. The series-connection of sheets in such collisions leads to strong, developed macro structures that have high electrical conductivity and a large surface, and can be used as a material for manufacturing supercapacitor electrodes. This method makes it possible to produce nanomaterials for the manufacture of supercapacitor electrodes which have high electrical conductivity and a large surface, and provides for high productivity and cost-effectiveness when producing the product.

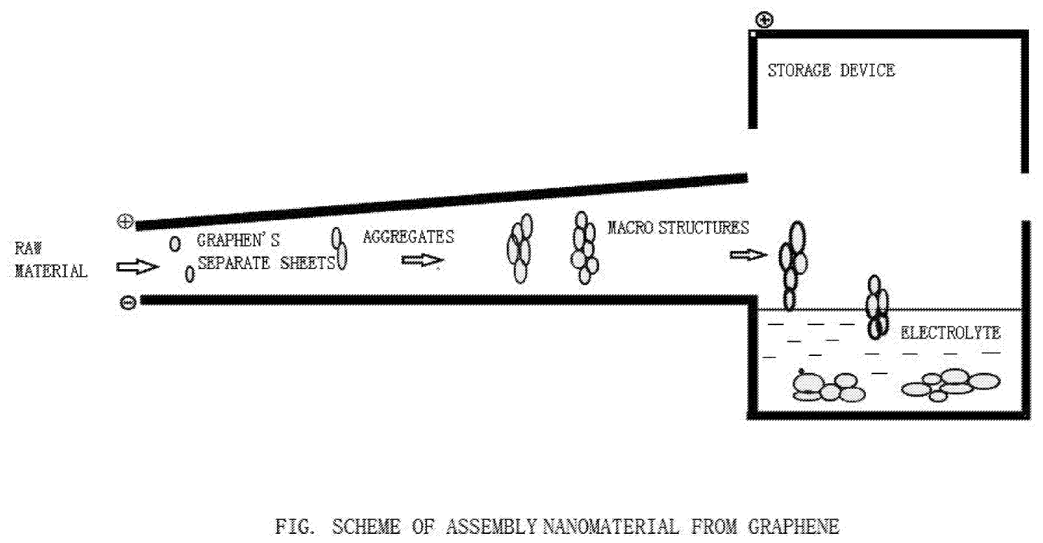

The invention relates to the production of carbon nanomaterials and can be used for the manufacture of electrodes in supercapacitors.

The main task in the manufacture of supercapacitors is to increase the capacity and electrical conductivity of materials for the manufacture of electrodes. The use of graphene in such materials increases their specific surface area up to 2600 m²/g and more (A. Eletsky, Production of a supercapacitor based on graphene using a laser, Perst, 2012, Volume 19, Issue 13/14).

A method obtaining a composite material for the electrode of a supercapacitor is known (RU2495509, published Oct. 10, 2013), which involving synthesis of electroconductive polymers or substituted derivatives thereof during oxidative polymerisation of corresponding monomers on the surface of carbon materials. The environmentally acceptable method involves conducting polymerisation in the presence of laccase enzyme, acidic dopants, an oxidant and an enzymatic reaction redox mediator, dissolved in the reaction mixture.

The disadvantage of the method is its low productivity due to long duration of stages for its implementation.

Known patent for a electrode material for electric capacitor, its manufacturing method, and electric supercapacitor. (RU2427052 published: Aug. 20, 2011). According to the invention an electrode active material having a metallized carbon base from a mixture of 70-90% activated carbon, electron-conducting additive 5-20%, and polymer binding agent with organic solvent 5-10%. Electron-conducting additive consists of multi-wall carbon nanotubes 2 μm long and with outer diameter of 15-40 nm and/or technical carbon with particle size of 13-120 nm. To obtain the electrode material, mixture before the seal is subjected to fibrillization at 50° C. Then molded the carbon active foundation and heat treated at a temperature of 100° C., followed by metallization. Electric supercapacitor includes electrodes made from electrode material.

The disadvantage of this method is in multi-stage and limited capacity when using traditional materials (activated carbon).

The problem to which this invention is directed is to produce nanomaterials for the manufacture of supercapacitor electrodes which have high electrical conductivity and a large surface, and provides for high productivity and cost-effectiveness when producing the product.

This problem is solved due to the fact that to obtain a material for the electrodes of the supercapacitor, a method of assembling graphene sheets is used, characterized in that: Graphene sheets are subjected to electrodynamic fluidization, in which, in the course of counter-collisions of graphene sheets with charges of the opposite sign, their edges are joined to form covalent bonds with the subsequent formation of aggregates and macrostructures.

The technical result provided by the above set of features is to produce nanomaterials for the manufacture of supercapacitor electrodes which have high electrical conductivity and a large surface, and provides for high productivity and cost-effectivenesS when producing the product.

The essence of the invention is as follows.

In the proposed method of obtaining the material, the process is performed in the mode of electrodynamic fluidization of graphene sheets in the electric field between differently charged electrodes. If in the free state graphene does not have rigidity and folds into a wad, then in an electric field when charged on the electrode, the graphene sheet is straightened by a Coulomb repulsion force into a flat particle. The oscillatory motion of particles between the electrodes when they are recharged on the electrodes occurs under the condition qU/d>mg, where q is the charge of the particle, U is the potential difference of the electrodes, d is the interelectrode distance, m is the mass of the particle, and g is the acceleration due to gravity. At a sufficiently high concentration of particles in the interelectrode space, two opposing oppositely charged streams of particles, undergoing collisions are formed. For colliding sheets of graphene, moving to the electrodes of the opposite sign of charge and oriented in the direction of the electric field, the collision occurs at the edges of the oncoming sheets. The edges of the graphene sheets contain carbon atoms with an unbound π-orbital, which form stable covalent compounds upon collision, and the sheets form an aggregate (composite particle). If the connection did not happen, and there was only an electrical contact, then the particles compensate each other for charge, the remaining charge is distributed according to their size and particles diverge due to Coulomb repulsion. In the future, the aggregate also experience collisions, become larger and turn into macrostructures, which are used for the manufacture of supercapacitor electrodes.

The attached FIGURE shows a scheme of the device for the implementation of the proposed method.

The method consists in the following.

As a source for obtaining the material, graphene sheets are used. Graphene sheets are placed in an electric field between two electrodes, with a potential difference sufficient for fluidization, when the force acting on the particle from the electric field Fₑ=qU/d is greater than gravity F_{g}=mg, where q is the charge of the particle, U is the potential difference of the electrodes, d is the interelectrode distance, m is the mass of the particle, and g is the acceleration due to gravity.

A two-dimensional lattice consists of graphene regular hexagons with sides d1=0, 1418 nm and an area of 5, 35×10⁻²⁰ m² by two carbon atoms per cell. (Eletskii A V, Iskandarov I M, Knizhnik A A and etc. Graphene: production methods and thermophysical properties. Uspekhi fizicheskikh nauk, ISSN 0042-1294, 2011, v. 181, No 3, 233-250.).

The specific gravity of graphene per unit area with a mass of one atom of carbon of 1.993·10⁻²⁶ kg is ρ_{gr}=2·1.993·10⁻²⁶ kg/5.35·10⁻²⁰ m²=7.45·10⁻⁷ kg/m². For a graphene sheet with an area S, lying on the electrode, the charge density equals the electrode charge density σ=ε₀U/d, where ε₀=8.85·10⁻¹² F/m—the permittivity . Then the charge of a graphene sheet is q=Sσ=Sε₀U/d. The mass of a graphene sheet is m=S·ρ_{gr}. The condition of fluidization of graphene sheets Fₑ>F_{g} gives the value of the required electric field strength U/d:

(U/d)²>(ρ_{gr}·g)/ε₀, U/d>0, 9·10³V/m,

which does not depend on the size of the graphene sheet.

This value is relatively small for ordinary values of the electric field strength at electrodynamic fluidization of about 10⁶ V/m, which indicates a large range of process control.

The speed of movement of particles during electrodynamic fluidization depends on the medium filling the interelectrode space. For a gas environment at atmospheric pressure with a small Reynolds number, the resistance of the environment to the movement of microparticles is determined by friction resistance, not form resistance, wherein with particles moving at a constant speed (Myazdrikov O. A. Electrodynamic fluidization of disperse systems. L: Chemistry, 1984.). According to Newton, the resistance force is F_{c}=η·(V/h)·S, where η is the kinematic viscosity of the environment, V is the velocity of the particle, h is the thickness of the boundary layer, and S is the surface area of the particle.

For spherical particles, S=4πr², where r is the particle radius, h=2/3r and F_{c}=6πηrV is the Stokes formula. Assuming that the graphene sheets have a shape close to a disk, we can take S=2πr², h=2/3r and then F_{c}=3πηrV. When F_{c}=Fₑ, the constant velocity of a particle of radius r is equal to:

V=(⅓)·(ε₀/η)·r·(U/d)².

Thus, the velocity of the particles is proportional to their size. This means that larger particles will have greater velocity and, consequently, a greater opportunity to attach smaller particles with further growth up to aggregates and macrostructures.

For U/d=10⁶ V/m and r=0.5·10⁻⁶ m, the velocity of particles in the air is 7.3·10⁻² m/s. For the effective formation of macrostructures requires a sufficient concentration of particles involved in the process of electrodynamic fluidization. Mathematical simulation of this process and comparison with experimental data (Zhebelev S. I. Statistical simulation of microparticle pseudoliquefaction within electrical field. J Eng Phys, ISSN 1062-0125, 1991 t. 60, No 1, p. 64-72) showed: when the quantity of collisions of particles is maximum, the concentration of microparticles exceeds the concentration of the monolayer N=1/(Sₐᵥ·d), where Sₐᵥ is the average particle area.

For Sₐᵥ=πr², r=0.5·10⁻⁶ m, d=10⁻² m, the concentration is N=1.27·10¹⁴ m⁻³. A sufficient concentration of particles can be obtained either by over-feeding the source material into the interelectrode space (with the formation of deposits of excess particles on the lower electrode) or by choosing special-shaped electrodes with a non-uniform electric field.

This method makes it possible to produce nanomaterials for the manufacturing of supercapacitor electrodes which have high electrical conductivity and a large surface, and provides for high productivity and cost-effectiveness when producing the product.

The ability to implement the claimed invention is shown by the following example.

### EXAMPLE

The FIGURE shows the scheme of the device for produce material.

The device uses two divergent electrodes to form a stream of particles also along the electrodes. Using the loading of the source material in a narrow part of the interelectrode space and unloading the product in its wider part. As it is known (Myazdrikov O. A. Electrodynamic fluidization of disperse systems. L: Chemistry, p. 355, 1984.) with non-parallel electrodes during self-oscillatory motion, particles move along curvilinear trajectories and due to centrifugal force are thrown towards lower field strength U/d.

The centrifugal force is proportional to the square of the velocity of movement of the particles between the electrodes V² and proportional to r⁴. Through environment resistance proportional to the particle size r, the velocity of movement of particles along the electrodes is proportional to r³. Thus, the larger the particle (macrostructure), the faster it leaves the interelectrode space. This property can also be used to pre-sort the source material by size, similar to chromatography for molecular substances. To prevent sticking of graphene sheets between themselves in the finished product when impregnated with electrolyte, this process should be carried out in a charged state. In the scheme of the device shown in the figure, a storage device is provided in which the product is in an electric field insufficient to fluidization the particles (less than 10³ V/m) but sufficient to charging them when the finished product is impregnated by electrolyte. It is advisable to fill the internal space of the device with helium (gas with low solubility and low adsorption capacity) to prevent the adsorption of extraneous gases on the surface of graphene and dissolving in the electrolyte.

Thus, this method makes it possible to produce nanomaterials for the manufacture of supercapacitor electrodes which have high electrical conductivity and a large surface, and provides for high productivity and cost-effectiveness when producing the product.

1. A method of producing a nano-material from graphene for producing electrodes of a supercapacitor, characterized in that, as a starting material graphene sheets are used, which are subjected to electro-dynamic liquefaction, at the opposite collisions of the sheets of the graphene with the charges of the opposite sign there is a connection of their edges with formation of covalent bonds with consequent formation of aggregates and macrostructures, which are used as material for making electrodes.

2. The method according to claim 1, characterized in that the macrostructure is immersed in the electrolyte in a charged state in order to prevent sticking of the graphene sheets;

3. The method according to claim 1, characterized in that the process is carried out under a helium atmosphere to prevent the adsorption of gases in the product obtained.
